(19) United States
(12) Patent Application Publication
(10) Pub. No.: US 2003/0069988 A1
(43) Pub. Date: Apr. 10, 2003

(54) In-band signaling

(76) Inventors: Johan Rune, Lidingo (SE); Martin Van Der Zee, Lund (SE)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 09/971,651

(22) Filed: Oct. 9, 2001

(51) Int. Cl. G06F 15/16

(52) U.S. Cl. 709/237

(57) ABSTRACT

Methods and apparatus are provided for in-band signaling of data which conventionally requires a separate packet. In-band signaling allows signaling data to be transferred in the same packet as user data. To transfer signaling data in the same packet as user data the present invention piggybacks the signaling data on the user data packet, thereby eliminating the need for a dedicated packet carrying signaling data. The logical channel field of a payload header of a baseband packet is used to indicate that a payload header extension is present. The payload header extension indicates the length of the signaling data field in the payload data section of the baseband packet. The payload header extension also includes an extended logical channel field which provides the indication that the normal logical channel field would have provided had it not indicated the presence of a payload header extension.

### BACKGROUND

The present invention relates to ad-hoe networks. More particularly, the present invention relates to signaling in ad-hoc networks.

Conventional networking protocols are based on the characteristics and/or features of fixed networks. In fixed networks, the network configuration typically does not change. Although nodes can be added and removed in fixed networks, the route traveled by data packets between two nodes typically does not change. The disadvantage is that fixed networks cannot be easily reconfigured to account for increases in data traffic, also called system loading. Accordingly, when system loading increases for one node, the surrounding nodes are likely to experience increased delays in the transmission and reception of data.

In contrast to fixed networks, ad-hoc networks are dynamic. An ad-hoc network is formed when a number of nodes decide to join together to form a network. Since nodes in ad-hoc networks operate as both hosts and routers, ad-hoc networks do not require the infrastructure required by fixed networks. Accordingly, ad-hoc networking protocols are based upon the assumption that nodes may not always be located at the same physical location.

Bluetooth is an exemplary ad-hoc networking technology. Bluetooth is an open specification for wireless communication of both voice and data. It is based on a short-range, universal radio link, and it provides a mechanism to form small ad-hoc groupings of connected devices, without a fixed network infrastructure, including such devices as printers, PDAs, desktop computers, FAX machines, keyboards, joysticks, telephones or virtually any digital device. Bluetooth operates in the unlicenced 2.4 GHz Industrial-Scientific-Medical (ISM) band.

FIG. 1 illustrates a Bluetooth piconet. A piconet is a collection of digital devices, such as any of those mentioned above, connected using Bluetooth technology in an ad-hoc fashion. A piconet is initially formed with two connected devices, herein referred to as nodes. A piconet can include up to eight nodes. In each piconet, for example piconet 100, there exists one master node and one or more slave nodes. In FIG. 1 Bluetooth unit 101 is a master node and Bluetooth unit 102 is a slave node.

According to Bluetooth technology a slave node can only communicate directly with a master node. FIG. 2 illustrates a piconet with a master node 201 and a plurality of slave nodes 202-208 arranged in a star network topology. If slave node 202 wishes to communicate with slave node 206, slave node 202 would have to transmit the information it wished to communicate to master node 201. Master node 201 would then transmit the information to slave node 206. In addition to being classified as a master node and slave node, a node may be classified as an idle node. An idle node is a node which is not currently participating in a piconet.

A scatternet is formed by multiple independent and unsynchronized piconets. FIG. 3 illustrates an exemplary scatternet 300. In FIG. 3, piconet 1 includes a master node 303 and the slave nodes 301, 302 and 304; piconet 2 includes the master node 305 and the slave nodes 304, 306, 307 and 308; and piconet 3 includes the master node 309 and the slave nodes 308, 310 and 311. To implement a scatternet it is necessary to use nodes which are members of more than one piconet. Such nodes are herein referred to as forwarding nodes. If, for example, node 301 wishes to communicate with node 310, then nodes 304 and 308 might act as forwarding nodes by forwarding data between the two piconets and in particular between nodes 301 and 310. For example, node 301 transfers the information to the master node of piconet 1 node 303. Master node 303 transmits the information to forwarding node 304. Forwarding node 304 then forwards the information to master node 305, which in turn, transmits the information to forwarding node 308. Forwarding node 308 forwards the information to master node 309 which transmits the information to the destination node 310.

Bluetooth nodes communicate using a frequency hopping scheme which consists of 79 separate frequencies. The particular frequency hop sequence for a piconet is based upon the address of the master node, and the phase of the frequency hop sequence is based on the clock of the master node. Therefore, proximate piconets may operate based on different frequency hop sequences. Having only a single transceiver, a Bluetooth node can only be active in one piconet at a time. Thus, participation in multiple piconets is performed on a time division basis.

Each Bluetooth node has a globally unique 48 bit IEEE 802 address. This address, called the Bluetooth Device Address (BD_ADDR) is assigned when the Bluetooth node is manufactured and it is never changed. In addition, the master node of a piconet assigns a local active member address (AM_ADDR) to each active member of the piconet. The AM_ADDR, which is only three bits long, is dynamically assigned and deassigned and is unique only within a single piconet. The master node uses the AM_ADDR when polling a slave node in a piconet. However, when the slave node, triggered by a packet from the master node addressed with the slave node's AM_ADDR, transmits a packet to the master node, it includes its own AM_ADDR (not the master node's) in the packet header.

FIG. 4 illustrates the communications format used in Bluetooth networks. In Bluetooth networks, each radio channel is divided into a series of time slots. As illustrated in FIG. 4, these time slots alternate between time slots reserved for transmissions in the master to slave direction and time slots reserved for transmission in the slave to master direction. A master to slave time slot and a slave to master time slot together form a frame, which is illustrated in FIG. 4 by the darkened borders between slave to master time slots of one frame and master to slave time slots of the next frame.

As illustrated in FIG. 4, each time slot in a Bluetooth network can include a standard Bluetooth packet which consists of an access code field, a header field and a payload field. The access code field can include: a channel access code (CAC), which is derived from the BD_ADDR of the master node of the piconet and identifies the channel used in the piconet; a device access code (DAC) which is derived from the BD_ADDR of a particular Bluetooth unit and is used for special signaling procedures such as the PAGE procedure (used for establishing connections to other Bluetooth units); or an inquiry access code (IAC) which are used in the INQUIRY procedure (used to “discover” other Bluetooth units within radio range). When an inquiry access code is used, there is no header field and no payload. When a device access code is used, the packet may also lack both header and payload. In this case the packet consisting only of a DAC is referred to as an ID-packet. When the packet includes a payload it may be longer than one time slot. Multi-slot packets may occupy three or five consecutive time slots.

The header of the standard Bluetooth packet includes a three bit AM_ADDR field, used for addressing the Bluetooth packet, a four bit type field which indicates the type of baseband packet used and a one bit flow field to control the flow over an Asynchronous Connectionless Link (ACL). It will be recognized that an ACL link carries asynchronous data. The header also includes a one bit ARQN field which is used for automatic repeat requests to indicate acknowledgment or negative acknowledgment of the previous packet sent in the opposite direction, a one bit SEQN field for sequential numbering of packets which include a cyclic redundancy check (CRC), i.e., it is used to detect duplicated packets, and an eight bit header error check (HEC) field to check the header integrity.

The payload field of the standard Bluetooth packet can take on one of two different formats depending upon whether the packet is a single-slot packet or a multislot packet. A single slot packet includes a two bit logical channel field (L_CH), a one bit flow field which is used for flow control of the entire data flow, a five bit length field which defines the length of the payload in bytes (excluding the payload header itself and the CRC), the payload body containing the information to be transmitted and a sixteen bit CRC field. The multislot packet has a similar configuration to the single slot packet except that the length field is nine bits long and there is a four bit undefined field between the length field and the payload body field.

Even though all data is transmitted in packets, the packets can carry both synchronous data, on Synchronous Connection Oriented (SCO) links which is mainly intended for voice traffic, and asynchronous data, on ACL links. Depending on the type of packet that is used, an acknowledgment and retransmission scheme is used (not for SCO packets transferring synchronous data) to ensure reliable data transfer, as well as forward error correction (FEC) in the form of channel coding.

FIGS. 5A and 5B respectively illustrate the current and a proposed protocol stack for Bluetooth units. In FIG. 5A, the protocol stack, from the lowest to the highest protocol layer, includes the baseband layer, the data link layer including the link management protocol (LMP) and the logical link control and adaptation protocol (L2CAP), the network layer and generally the higher layer protocol or the application layer.

In order to support Internet Protocol (IP) in a Bluetooth scatternet, it has been proposed to regard an entire Bluetooth scatternet as an IP subnet. However, to do this requires an adaptation layer. Accordingly, FIG. 5B includes the proposed network adaptation layer between the data link layer and the network layer to allow Bluetooth units to communicate using IP. This network adaptation layer can be generally referred to as the network adaptation layer (NAL), or more specifically, as the Bluetooth Network Encapsulation Protocol (BNEP).

Bluetooth was designed to be a low-cost, low-power wireless system, and as a result, bandwidth is a scarce resource. The current signaling mechanisms, LMP signaling and BNEP signaling, require a dedicated baseband packet for each signaling message, irrespective of the amount of signaling data that is transferred. Since each time slot can carry at most one single-slot baseband packet, or a portion of a multi-slot packet, if the signaling data does not fill the entire portion of the packet useable for the signaling data, the remainder of the time slot is unused. Accordingly, the current signaling mechanisms in Bluetooth are inefficient for transferring small amounts of data. Another deficiency of LMP signaling is that it has very relaxed timing requirements. Specifically, the link manager has thirty seconds to react to a received LMP protocol data unit (PDU). The relaxed timing requirements of LMP signaling make it difficult to introduce mechanisms which require frequent signaling to work efficiently, even when the accumulated amount of signaling data may be small.

Accordingly, it would be desirable to provide methods and apparatus which can efficiently transfer small amounts of signaling data. Specifically, it would be desirable to avoid using a dedicated single-slot baseband packet, which effectively uses an entire time slot irrespective of the amount of data in the single-slot packet, to transfer signaling data when the amount of signaling data is significantly smaller than the total amount of signaling data that can fit in a full single-slot baseband packet. Moreover, it would be desirable to provide methods and apparatus for signaling which can satisfy the strict, or semi-strict, timing requirements. Further, it would be desirable to provide efficient signaling which is backward compatible with existing Bluetooth devices.

### SUMMARY

These and other problems, drawbacks and limitations of conventional techniques are overcome according to the present invention. Specifically, the present invention provides for in-band signaling. In-band signaling allows signaling data to be transferred in the same packet as user data. To transfer signaling data in the same packet as user data the present invention piggybacks the signaling data on the user data packet, thereby eliminating the need for a dedicated packet carrying signaling data. The logical channel field of a payload header of a baseband packet is used to indicate that a payload header extension is present. The payload header extension indicates the length of the signaling data field in the payload data section of the baseband packet. The payload header extension also includes an extended logical channel field which provides the indication that the normal logical channel field would have provided had it not indicated the presence of a payload header extension.

The type of signaling data which can benefit from in-band signaling includes, but is not limited to, inter-piconet scheduling messages, intra-piconet scheduling feedback, coordination of inquiry scan and page scan schedules and quality of service (QoS) indications.

In accordance with one aspect of the present invention, signaling data is provided by a first node to a second node. A packet is generated wherein the packet includes a header section and a payload section, the payload section includes a payload header and a payload data section. A first payload header is formed. An extended payload header is formed if signaling data is included in the payload data section, wherein the first payload header includes an indication of whether the extended payload header is present. The packet is transmitted from the first node to the second node.

In accordance with another aspect of the present invention, a first node determines whether the second node supports packets which include both signaling and user data in a payload of a packet. If the second node supports packets which include both signaling and user data in a payload of a packet, the first node generates a packet which includes signaling data and user data in a payload data section of the packet. If the second node does not support packets which include both signaling and user data in a payload of a packet, the first node generates a packet which includes only signaling data in the payload data section. The first node transmits the generated packet to the second node.

### BRIEF DESCRIPTION OF THE DRAWINGS

The objects and advantages of the invention will be understood by reading the following detailed description in conjunction with the drawings in which:

FIG. 1 illustrates an exemplary piconet;

FIG. 2 illustrates an exemplary star-topology network;

FIG. 3 illustrates an exemplary scatternet formed by a plurality of piconets;

FIG. 4 illustrates a conventional Bluetooth packet;

FIGS. 5A and 5B respectively illustrate the protocol layers of the current Bluetooth protocol and of an Internet Protocol compatible Bluetooth protocol;

FIG. 6 illustrates an exemplary asynchronous connectionless link packet in accordance with one embodiment of the present invention;

FIG. 7 illustrates an exemplary synchronous connection oriented (SCO) packet carrying voice data, user data and signaling data in accordance with the present invention;

FIGS. 8A and 8B respectively illustrate an extended baseband payload header for single and multi slot packet in accordance with the present invention;

FIG. 9 illustrates an exemplary method for a node sending signaling data in accordance with the present invention;

FIG. 10 illustrates an exemplary method for a node receiving signaling data in accordance with the present invention;

FIG. 11 illustrates an exemplary apparatus for implementing in-band signaling in accordance with the present invention; and

FIG. 12 illustrates an exemplary alternative payload format in accordance with one embodiment of the present invention.

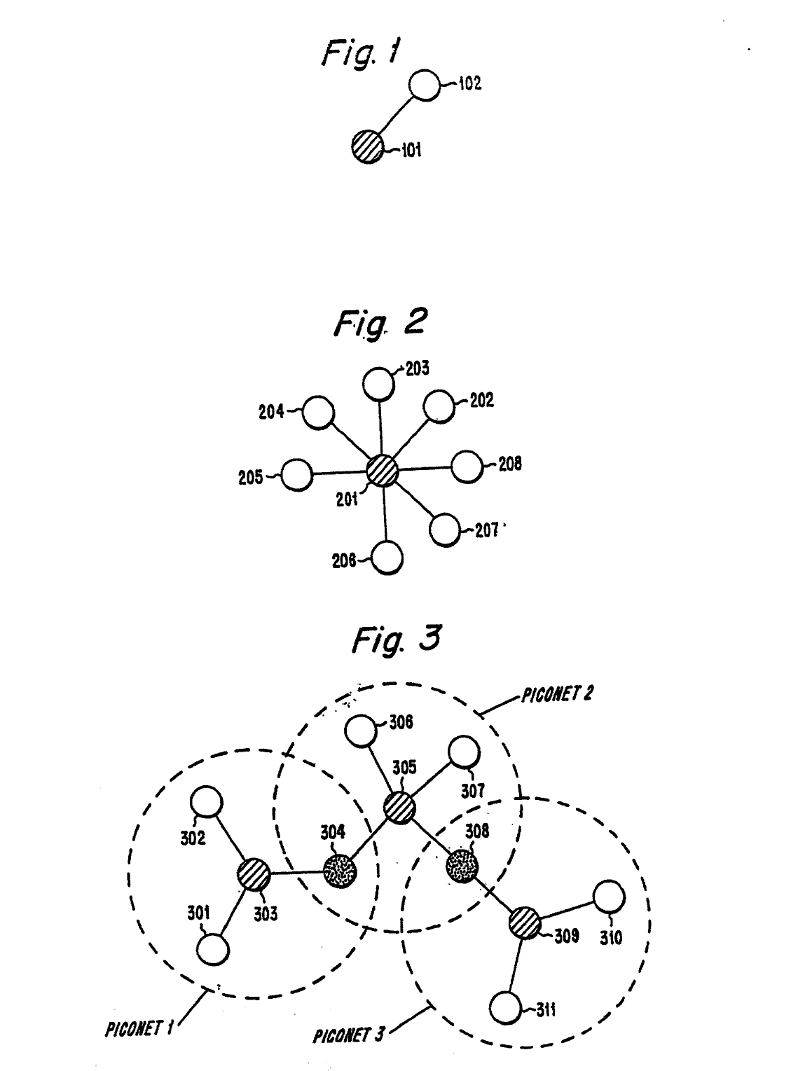

### DETAILED DESCRIPTION

The present invention is directed to ad-hoe networks. More particularly, the present invention is directed to efficiently transferring signaling data in an ad-hoc network.

In the following description, for purposes of explanation and not limitation, specific details are set forth, such as particular sequences of inter and intra network signaling, types of messages, etc. in order to provide a thorough understanding of the present invention. However, it will be apparent to one skilled in the art that the present invention may be practiced in other embodiments that depart from these specific details. In other instances, detailed descriptions of well-known methods, devices, and network elements are omitted so as not to obscure the description of the present invention.

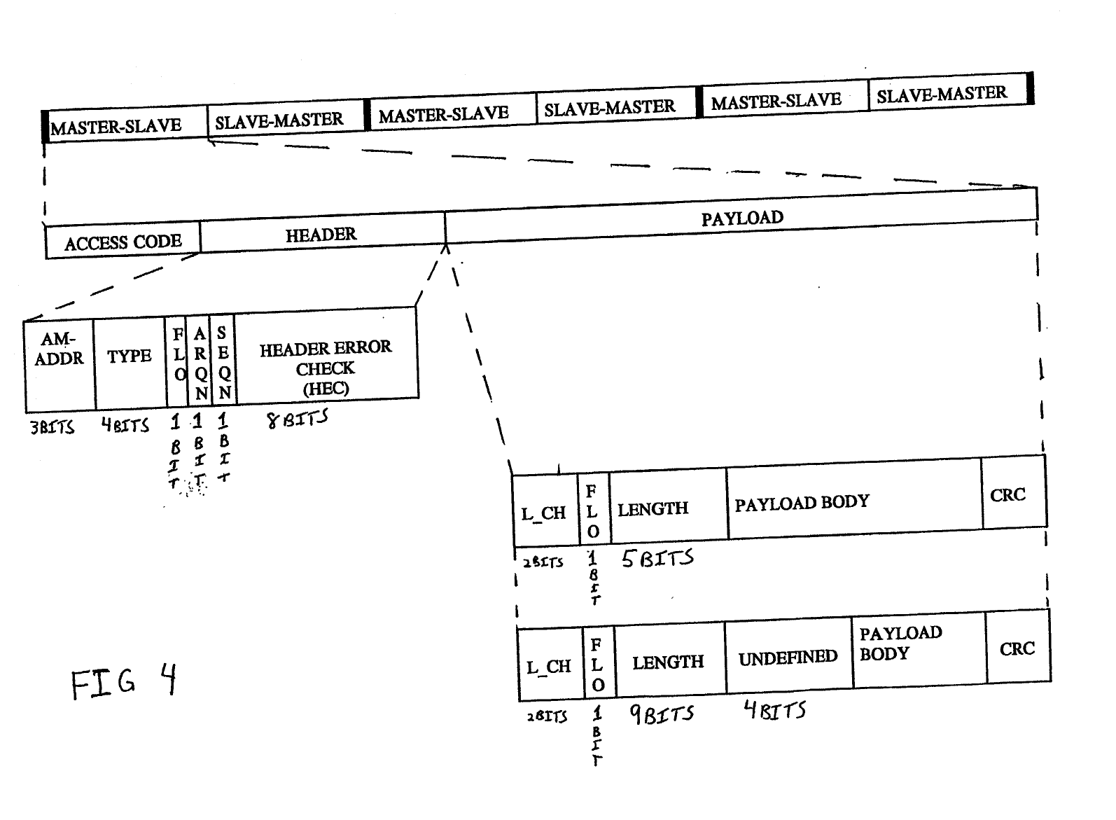

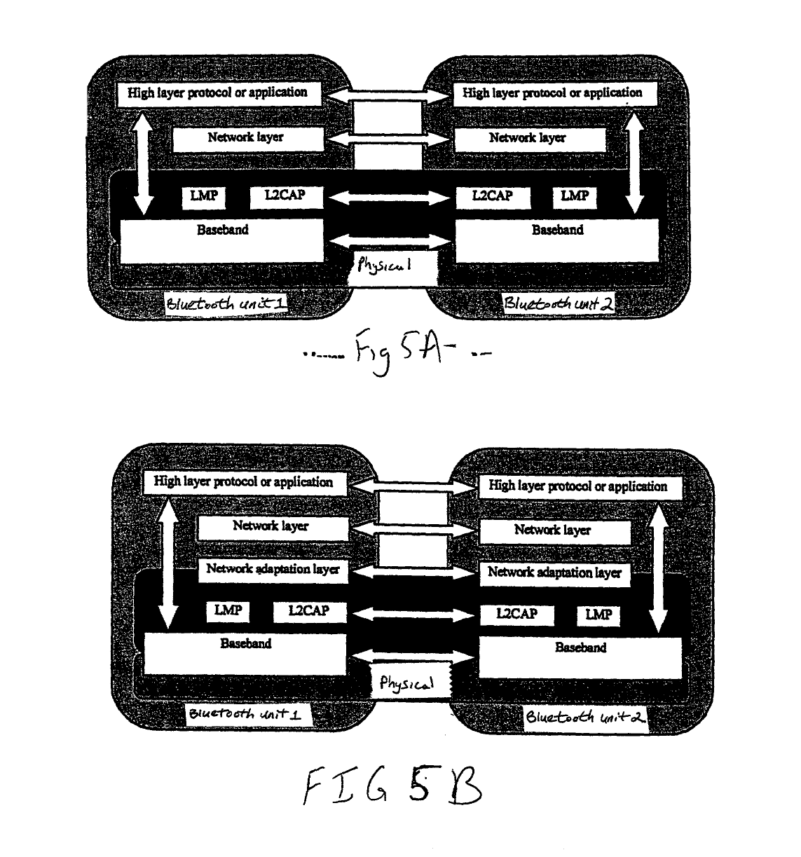

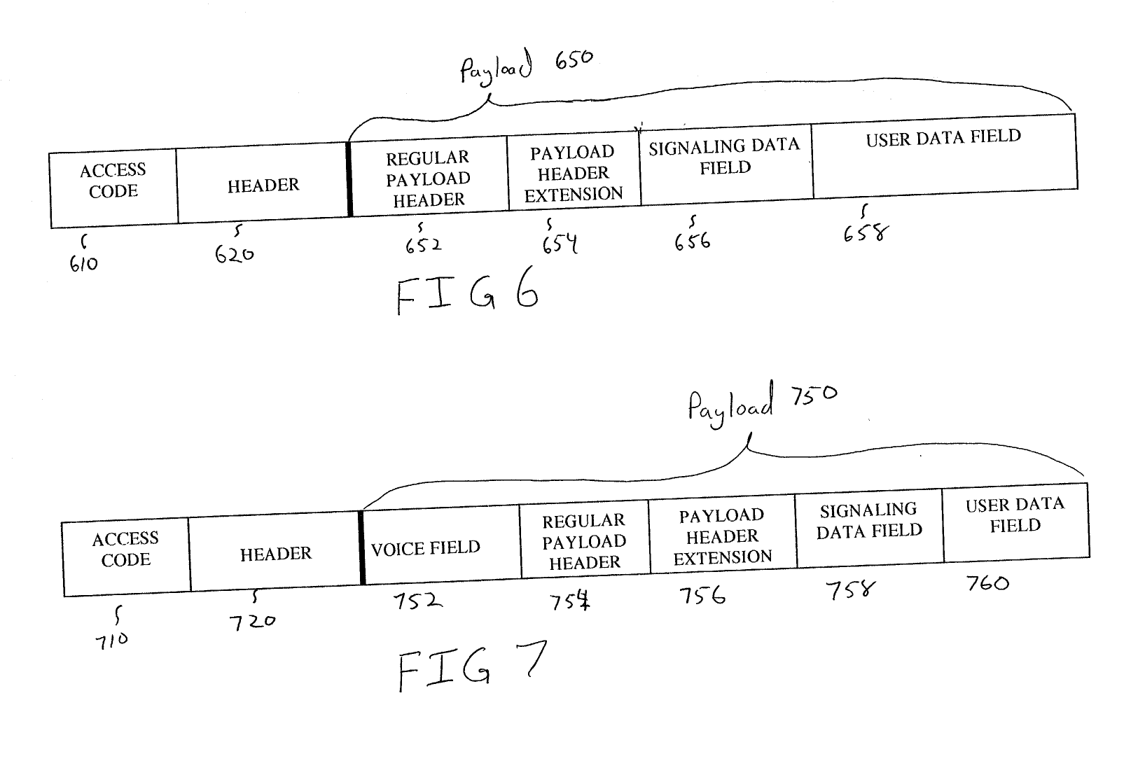

FIGS. 6 and 7 respectively illustrate an asynchronous connectionless packet (ACL) and a synchronous connection oriented (SCO) packet which can provide in-band signaling in accordance with exemplary embodiments of the present invention. Referring now to FIG. 6, the baseband packet comprises an access code field 610, baseband packet header 620 and a payload 650. The access code field 610 and the baseband packet header 620 are arranged and function the same as the access code field and the baseband packet header described above in connection with FIG. 4. In accordance with the present invention, if in-band signaling is desired, the baseband packet payload 650 will include a regular payload header 652, a payload header extension 654, a signaling data field 656 and a user data field 658. The darkened line in FIG. 6 illustrates the division of the packet between the baseband header and the baseband payload.

The SCO packet illustrated in FIG. 7 is a packet which carries voice data, user data and signaling data in accordance with exemplary embodiments of the present invention. Conventionally, a packet which carries both user data and voice data is referred to as a DV packet. The SCO packet illustrated in FIG. 7 includes an access code field 710, a baseband packet header 720 and a baseband packet payload 750. The access code field 710 and the baseband packet header 720 are arranged and function the same as the access code field and baseband packet header described above in connection with FIG. 4. In accordance with the present invention, if in-band signaling is desired, the baseband packet payload 750 includes a voice field 752, a regular payload header 754, a payload header extension 756, a signaling data field 758 and a user data field 760. It should be recognized that the signaling data included in the signaling data field in FIGS. 6 and 7 is not the type of data which would be placed in the header portions of the baseband packet. Specifically, the data in the header portions of the baseband packet has a predefined relation to the user data in the user data field. The signaling data in the signaling data field typically does not have this predefined relation. However, there is nothing which would prohibit a predefined relation between the user data in the user data field and the signaling data in the signaling data field.

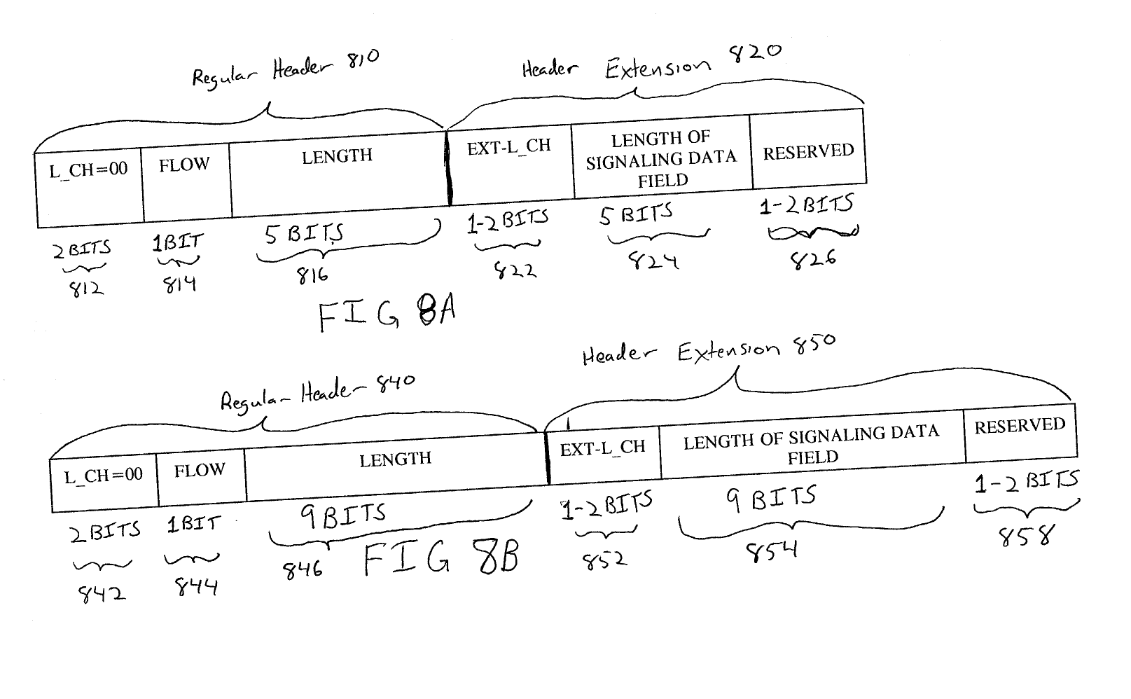

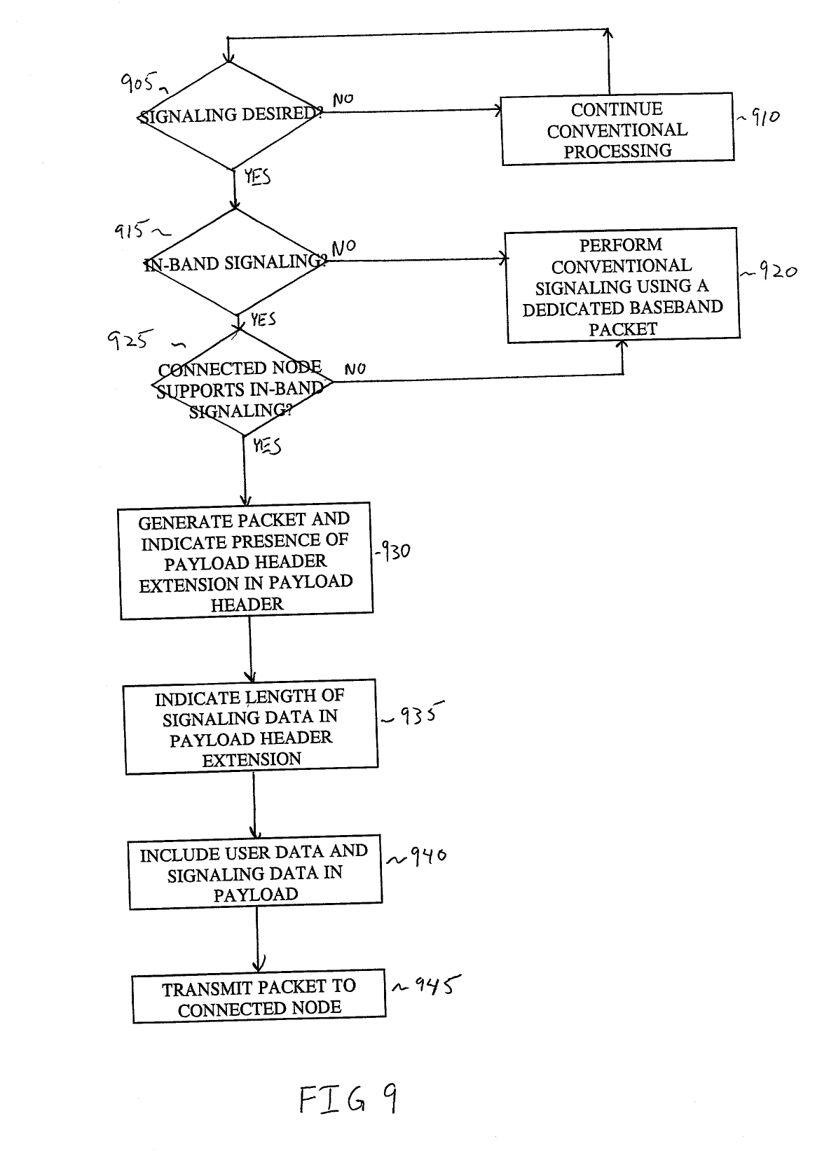

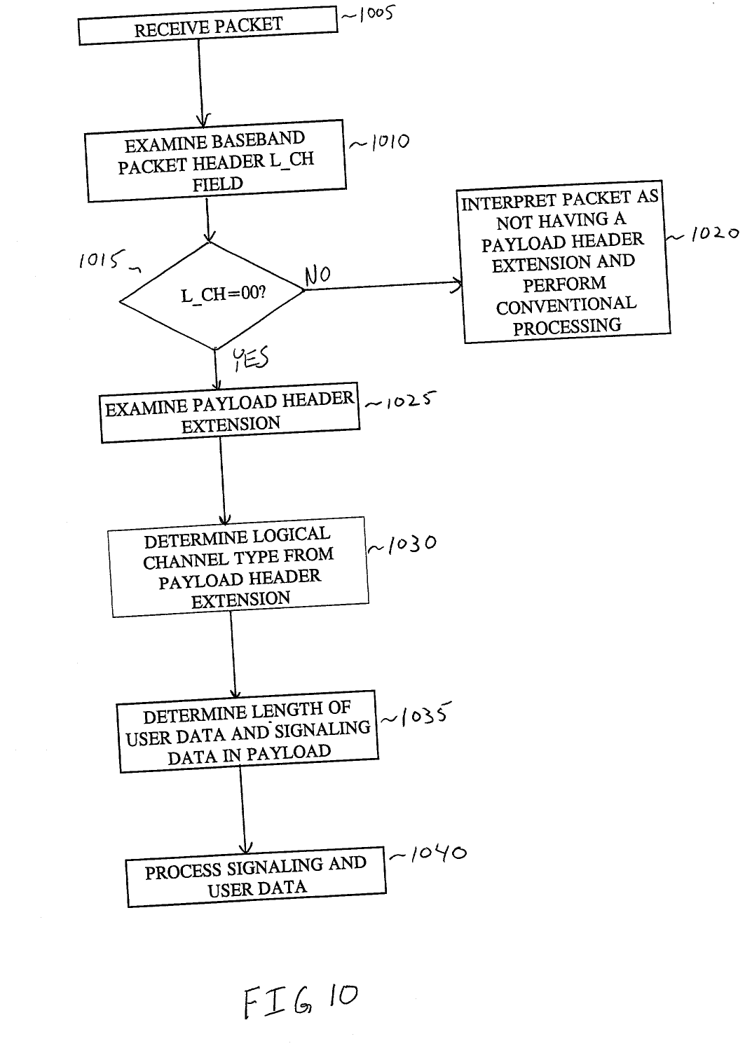

FIGS. 8A and 8B illustrate the baseband packet header and header extension for a single slot packet and a multi-slot packet, respectively, in accordance with exemplary embodiments of the present invention. Referring now to FIG. 8A, a single slot packet includes a regular header 810 and a header extension 820. The regular header is conventional in its format, i.e., the two bit L_CH field 812, the one bit flow field 814 and the five bit length field 816 are the same structure as in conventional baseband packet headers. However, in accordance with the present invention, the L_CH field 812 is used to indicate the presence of header extension 820. More specifically, when the value of the two bit L_CH field 812 is set to ‘00’, a node receiving the packet can determine that the baseband packet includes a payload header extension 820. The payload header extension 820 includes a one or two bit extended L_CH field (EXT-L_CH) 822, a five bit length of signaling data field 824 and a one or two bit reserved field 826.

Since the L_CH field is set to ‘00’ if the payload header includes a header extension, the L_CH field cannot perform its normal function of indicating whether the baseband packet is a start or a continuation of an L2CAP packet. Accordingly, the present invention provides an EXT-L_CH field 822 in the payload header extension 820 to perform this function. Two alternative formats for the EXT-L_CH field are presented. In the first format, the EXT-L_CH field 822 is a single bit field. Accordingly, a zero bit can indicate the start of an L2CAP packet or no fragmentation, and a one bit can indicate a continuation fragment of an L2CAP packet or only signaling data, or vice versa. In accordance with the second format the EXT-L_CH field is a two bit field. The value ‘00’ indicates only signaling data, ‘01’ indicates continuation fragment of an L2CAP packet, ‘10’ indicates the start of an L2CAP packet or no fragmentation, and ‘11’ is reserved for future use. It should be recognized that the meanings of the values ‘00’ and ‘11’ could be swapped.

The length of signaling data field 824 indicates the size, in number of bytes, of the signaling data field in the payload. The reserved field 826 is either a one bit or two bit field depending upon the size of the EXT-L_CH field. If the EXT-L_CH field is one bit, the reserved field is two bits, and vice versa. It will be recognized that once the in-band signaling of the present invention is implemented in a system, the size of the EXT-L_CH field and the reserved field will each be a predetermined fixed length. In other words, both the node transmitting the packet and the node receiving the packet need to know the size of these fields. This is normally known because the size of the fields is predefined for all nodes operating in a system, usually in the software or firmware, running in each node. The description of these fields as being either one or two bits in length is intended to provide flexibility to a system designer prior to system implementation.

The multi-slot packet payload header illustrated in FIG. 8B includes similar fields to those described above in connection with FIG. 8A, and hence, these similar fields operate in a similar manner to those fields described above in connection with FIG. 8A. The multi-slot packet payload header includes a regular header 840 and a header extension 850. The regular header includes a two bit L_CH field 842, a one bit flow field 844 and a nine bit length field 846. If in-band signaling is desired, the L_CH field 842 is set to a value of ‘00’, otherwise the field will be used for its conventional purpose of identifying whether the packet is the start of an L2CAP packet or no fragmentation, whether the packet is a continuation fragment of an L2CAP packet, or whether the packet carries an LMP PDU. The flow field 844 and the length field 846 are used for their conventional purposes as described above in connection with FIG. 4.

The payload header extension 850 of FIG. 8B includes a one or two bit EXT-L_CH field 852, a nine-bit length of signaling data field 854 and a one or two bit reserved field 858. The two alternative formats for the EXT-L_CH field 822 of FIG. 8A are equally applicable to the EXT-L_CH field 852 of FIG. 8B. Accordingly, further discussion of EXT-L CH field 852 is omitted as duplicative. Similarly, whether the reserved field 858 is one bit or two bits in length is determined by the system designer prior to implementation based upon the size used for the EXT-L_CH field.

Returning now to FIGS. 6 and 7, there are two possible formats for the signaling data included in the signaling data field. In accordance with the first format, the signaling data field can carry multiple different types of signaling data. Accordingly, the signaling data field would include a code indicating the receiving entity in the receiving node (e.g., the link manager, the NAL entity or a scheduling entity) of the signaling data and the length of the signaling data prior to each separate piece of signaling data in the signaling data field. This code could be seen as corresponding to well-known concepts like protocol identifier or port identifier which are used to direct received data to the correct upper protocol layer or application within the node receiving the data. Alternatively, the system can operate to allow only a single piece of signaling data in the signaling data field. Accordingly, the signaling data field, in addition to the signaling data, need only contain a code indicating the receiving entity in the receiving node, e.g., the link manager, the NAL entity or a scheduling entity, of the signaling data since the length of the signaling data is already provided in the payload header extension.

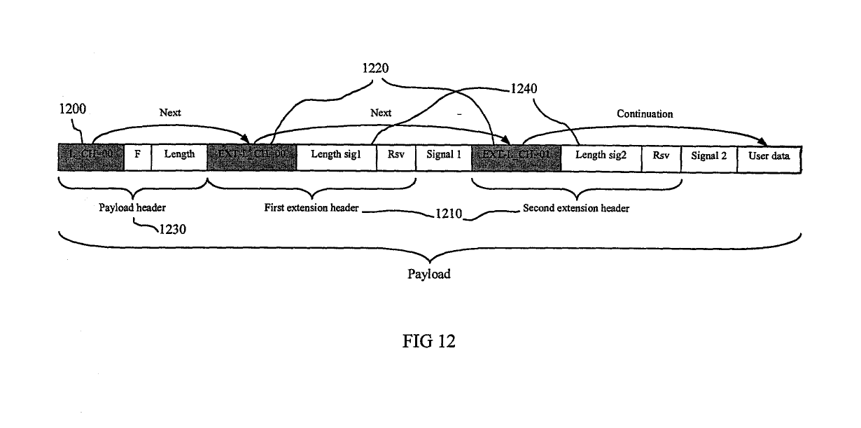

FIG. 12 illustrates an alternative technique for including multiple pieces of signaling data in the same baseband packet. In accordance with this technique several similar extension headers are include, one for each piece of signaling data. Each extension header 1210 contains an extended logical channel field (EXT-L_CH), a length field and a reserved field. In accordance with this technique each extension header has an indication of the presence or absence of a subsequent extension header. The EXT-L_CH fields 1220 in the extension headers 1210 are used for this indication, similar to the use of the L_CH field 1200 in the regular payload header 1230 which is used to indicate the presence of the first extension header. The EXT-L CH fields are each two bits long. The value ‘00’ indicates the presence of a subsequent extension header; the value ‘01’ indicates that the user data field is a continuation fragment of an L2CAP packet; the value ‘10’ indicates that the user data field is the start of an L2CAP packet or a non-fragmented L2CAP packet; and the value ‘11’ indicates that only signaling data is present, i.e., a zero length user data field. Alternatively, the value ‘10’ could indicate a continuation fragment of an L2CAP packet or only signaling data (i.e., a zero length user data field); and the value ‘11’ could then be reserved for future use. Referring now to the exemplary payload illustrated in FIG. 12, the L_CH field which is in the payload header has a value of ‘00’ which indicates that an extension header is present. The first EXT-L_CH field has a value of ‘00’ thereby indicating the presence of an additional extension header. The second EXT-L_CH field has a value of ‘01’ thereby indicating that the user data field is a continuation fragment of an L2CAP packet.

The length field 1240 in each extension header 1210 indicates the length of only the immediately following signaling data (i.e., up to the subsequent extension header, or for the last piece of signaling data, up to the start of the user data field). The signaling data is placed in signaling data fields signal 1 and signal 2. Since the length is indicated in each extension header, the signaling data following each extension header would only need a code (not illustrated) indicating the receiving entity in the receiving node preceding the actual piece of signaling data. Irrespective of the structure of the entire signaling data field, the formats of the actual pieces of signaling data depends upon the signaling entities, i.e., the protocol that the data is a part of. One possible structure is the well-known Type-Length-Value (TLV) format. Furthermore, in order to further improve real-time properties of in-band signaling, a value of L_CH=‘00’ can indicate that the in-band signaling data is time critical in addition to indicating that an extension header is present. Such baseband packets could then be given special treatment in order to ensure quick delivery of the in-band signaling data.

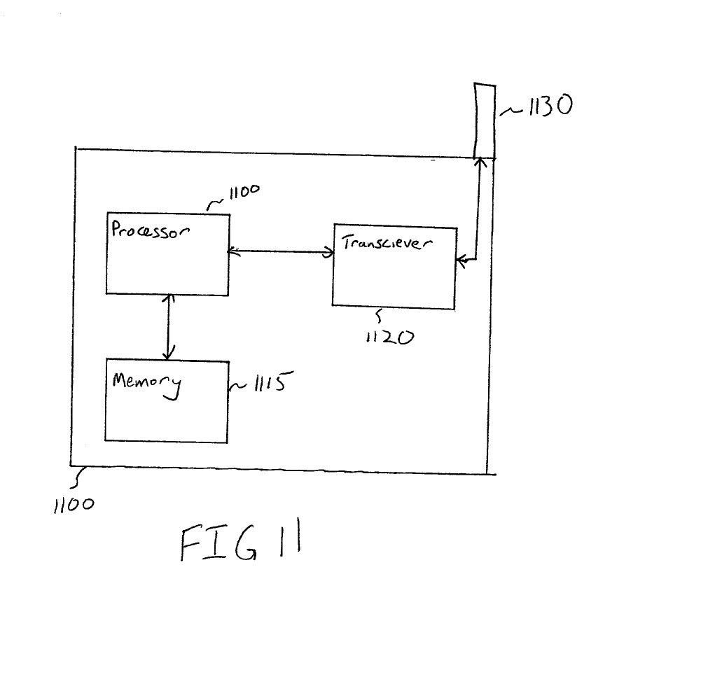

FIG. 9 illustrates a method for providing signaling by a transmitting node in accordance with exemplary embodiments of the present invention. The transmitting node initially determines whether signaling is desired (step 905). If signaling is not desired (“No” path out of decision step 905), then the transmitting node continues to perform conventional processing (step 910) until it is determined that signaling is desired. If, however, signaling is desired by the transmitting node (“Yes” path out of decision step 905), then it is determined whether in-band signaling is desired (step 915). The determination of whether in-band signaling is desired can be based upon the amount of signaling data, i.e., the number of bits, to be transferred. For example, assume a single time slot can carry M number of signaling bits. If the number of signaling bits to be transferred is significantly less than M number of bits, e.g., less than half, then the signaling bits would be sent using in-band signaling instead of using a whole time slot to transfer the signaling data in a single-slot packet. It should be recognized that the determination of what is substantially less than M bits is not limited to the example of less than half of M bits presented above. Instead, the determination should be made by the system designer based upon a desired bandwidth efficiency for the system.

If in-band signaling is not desired (“No” path out of decision step 915), then the node performs conventional signaling using a dedicated baseband packet for the signaling data (step 920). If in-band signaling is desired (“Yes” path out of decision step 915), then it is determined whether the connected node, i.e., the node which is directly reachable from the node which is sending the in-band signaling, supports in-band signaling (step 925). To determine whether the connected node supports in-band signaling, the transmitting node can exchange LMP_features_req/LMP_features_res protocol data units (PDUs). The LMP_features_req/LMP_features_res PDUs are link management protocol mechanisms for nodes to exchange lists of supported and unsupported features so that only features supported by both nodes are used. If the connected node does not support in-band signaling (“No” path out of decision step 925) then the node performs conventional signaling using a dedicated baseband packet for the signaling data (step 920).

If the connected node supports in-band signaling (“Yes” path out of decision step 925), the transmitting node generates the baseband packet and provides an indication in the payload header of the presence of a payload header extension (step 930). Next the node indicates the length of the signaling data in the payload header extension (step 935). Finally, the node includes the user data and the signaling data in the payload of the baseband packet (step 940) and transmits the packet to the connected node (step 945). The section of the payload which includes the signaling data and the user data can be referred to as the payload data section of the baseband packet.

FIG. 10 illustrates a method for a node receiving a baseband packet in accordance with exemplary embodiments of the present invention. The node receives a packet (step 1005) and examines the baseband packet header L_CH field (step 1010). If the L_CH field has a value other than ‘00’ (“No” path out of decision step 1015), then node interprets the packet as not having a payload header extension and the node performs conventional processing on the packet (step 1020).

If the L_CH field in the payload header has a value of ‘00’ (“Yes” path out of decision step 1015), then the receiving node examines the payload header extension (step 1025). Next the receiving node determines the logical channel type by examining the EXT-L_CH field in the payload header extension (step 1030) and determines the length of the user data and the signaling data (step 1035). Finally, the node processes the signaling and user data (step 1040).

FIG. 11 illustrates an exemplary apparatus for implementing in-band signaling in accordance with the present invention. The apparatus 1100 includes a processor 1110, a memory 1115, a transceiver 1120 and an antenna 1130. Although not illustrated in FIG. 11, depending upon the ultimate purpose of the apparatus, the apparatus 1100 can further include a display, a keyboard, a speaker and/or a microphone. The processor 1110, in conjunction with software stored in memory 1115, performs the processing described above in the method figures. The transceiver 1120 in conjunction with the antenna 1130 are used for transmitting packets to, and receiving packets from neighboring nodes. Although the processor 1110 and memory 1115 are illustrated as being separate devices, the processor 1110 can include an on-chip memory. Further, although FIG. 11 illustrates a processor in conjunction with a memory performing the processing, the in-band signaling of the present invention can also be performed by replacing the processor and memory with hard-wired logic.

Two other forms of in-band signaling have been recognized, however it has been found that the in-band signaling described above provides advantageous characteristics not provided by these other forms of in-band signaling. One method for in-band signaling extends the baseband packet header and includes a one bit indicator of whether there is signaling data included in the payload data section of the baseband packet. Since Bluetooth devices are currently not designed to recognize an extended baseband packet header, extending the baseband packet header creates a backward compatibility problem.

Even if the extended baseband packet header were only used between Bluetooth devices which support these types of headers, the backwards compatibility problem is not completely overcome. Specifically, all slaves which are active in a piconet are required to interpret the baseband packet header of all received baseband packets with a valid channel access code, i.e., all baseband packets which are transferred within the piconet in which a particular slave is a member. If the AM ADDR of the baseband packet header does not match the slave's own AM_ADDR, i.e., the packet is not specifically addressed to the slave, the slave examines the TYPE field to determine how many slots the slave can sleep for before having to activate its receiver, i.e., since a multi-slot packet comprises a plurality of consecutive time slots, if the node is not the intended destination of the multi-slot packet, the node can sleep for the consecutive time slots of the multi-slot packet. Accordingly, if not all slaves in a piconet support extended baseband packet headers, slaves which do not support the extended baseband packet header will not be able to interpret the extended header since the HEC will fail. Since the present invention described above in connection with FIGS. 6-11 uses the ‘00’ value of the L_CH field which is not an assigned value, the present invention does not encounter this type of backward compatibility problem.

A second possible method for in-band signaling can be achieved by the assignment of one or more new packet type codes to be included in the TYPE field of the baseband packet header. These new packet types can indicate that signaling data is mixed with user data. Further, each new type code can indicate a different combination of the number of time slots and level of channel coding of the signaling data. Currently all but two combinations of bits in the TYPE field are used. Accordingly, there are not enough remaining packet type codes to indicate that the different ACL packet types include both signaling and user data in the payload data section of the baseband packet. This deficiency can be overcome by allowing the type codes to have different meanings depending upon whether the packet is associated with an ACL or SCO connection. However, slaves would no longer be able to interpret the TYPE field in the baseband packet header to derive the number of slots allocated to a packet that is not addressed to the slave itself since the slave will not know whether the packet is sent over an ACL or SCO connection. An additional disadvantage of this mechanism is that all currently unused codes for ACL packets would be assigned, thereby leaving no extra codes for future ACL packet types.

From the discussion above, it can be seen that in addition to the general advantages provided by in-band signaling in accordance with the present invention, the particular type of in-band signaling in accordance with the present invention provides the greatest flexibility for the system designer without introducing backward compatibility problems for existing devices.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for providing signaling data by a first node to a second node comprising the steps of:
generating a packet, the packet including a header section and a payload section, the payload section includes a payload header and a payload data section, wherein the step of generating a packet further comprises the steps of
forming a first payload header, and
forming an extended payload header if signaling data is included in the payload data section, wherein the first payload header includes an indication of whether the extended payload header is present; and
transmitting the packet from the first node to the second node.

2. The method of claim 1, wherein the packet is a synchronous connection oriented packet (SCO) and the payload data section includes voice data, user data and signaling data, wherein the signaling data is not related to the voice data in the payload data section.

3. The method of claim 1, wherein the packet is an asynchronous connectionless (ACL) packet and the payload data section includes user data and signaling data.

4. The method of claim 1, wherein the step of forming the extended payload header further comprises the step of:
including an indication in the extended payload header of a length of the signaling data in the payload data section.

5. The method of claim 4, further comprising the step of:
indicating a length of the payload data section, thereby implicitly indicating the size of the user data portion in the payload data section.

6. The method of claim 1, wherein the signaling data includes inter-network scheduling messages, intra-network scheduling feedback, co-ordination of inquiry scan and page scan schedules or quality of service (QoS) indications.

7. The method of claim 1, wherein the first payload header includes a logical channel field, the logical channel field indicating whether the extended header is present.

8. The method of claim 7, further comprising the step of:
generating a second logical channel field in the extended header, the second logical channel field indicating the logical channel of the user data.

9. The method of claim 7, wherein the logical channel field has a value of ‘00’ if the extended header is present.

10. The method of claim 1, wherein the step of generating the packet includes the step of:
inserting the signaling and user data into the payload data section, wherein only a single piece of signaling data can be inserted into the payload data section and the single piece of signaling data is preceded by an indication of an entity in the second node which is an intended recipient of the signaling data.

11. The method of claim 1, wherein the step of generating the packet includes the step of:
inserting the signaling and user data into the payload data section, wherein each piece of signaling data is inserted into the payload data section subsequent to an indication of an entity in the second node which is an intended recipient of the piece of signaling data and the length of the piece of signaling data.

12. The method of claim 11, wherein the inserting step further comprises the step of:
generating an extended header preceding each piece of signaling data, the extended header including the indication of the length of the piece of signaling data.

13. A method for providing signaling data from a first node to a second node comprising the steps of:
determining, by the first node, whether the second node supports packets which include both signaling and user data in a payload of a packet;
generating, by the first node, a packet which includes signaling data and user data in a payload data section of the packet if the second node supports packets which include both signaling and user data in a payload of a packet;
generating, by the first node, a packet which includes only signaling data in the payload data section if the second node does not support packets which include both signaling and user data in a payload of a packet; and
transmitting, by the first node, the generated packet to the second node.

14. The method of claim 13, wherein the generated packet including signaling data and user data is a synchronous connection oriented packet (SCO) and the payload data section also includes voice data, wherein the signaling data is not related to the voice data in the payload data section.

15. The method of claim 13, wherein the generated packet including signaling data and user data is an asynchronous connectionless (ACL) packet.

16. The method of claim 13, wherein the step of generating a packet which includes signaling data and user data further comprises the step of:
forming a first payload header;
forming an extended payload header, wherein the first payload header includes an indication of whether the extended payload header is present.

17. The method of claim 16, wherein the step of forming the extended payload header further comprises the step of:
including an indication in the extended payload header of a length of the signaling data in the payload data section.

18. The method of claim 17, further comprising the step of:
indicating a length of the payload data section, thereby implicitly indicating the size of the user data portion in the payload data section.

19. The method of claim 13, wherein the signaling data includes inter-network scheduling messages, intra-network scheduling feedback, co-ordination of inquiry scan and page scan schedules or quality of service (QoS) indications.

20. The method of claim 16, wherein the first payload header includes a logical channel field, the logical channel field indicating whether the extended header is present.

21. The method of claim 20, further comprising the step of:
generating a second logical channel field in the extended header, the second logical channel field indicating the logical channel of the user data.

22. The method of claim 21, wherein the logical channel field has a value of ‘00’ if the extended header is present.

23. The method of claim 13, wherein only a single piece of signaling data can be inserted into the payload data section and the single piece of signaling data is preceded by an indication of an entity in the second node which is an intended recipient of the signaling data.

24. The method of claim 13, wherein each piece of signaling data is inserted into the payload data section subsequent to an indication of an entity in the second node which is an intended recipient of the piece of signaling data and the length of the piece of signaling data.

25. The method of claim 24, wherein the insertion of signaling data into the payload data section comprises the step of:
generating an extended header preceding each piece of signaling data, the extended header including the indication of the length of the piece of signaling data.

26. The method of claim 13, wherein the first node generates a packet which includes signaling data and user data in the payload data section only if the signaling data is less than a predetermined number of bits.

27. A device comprising:
a processor which generates a packet, the packet including a header section and a payload section, the payload section includes a payload header and a payload data section,
wherein if signaling data is included in the payload data section, the generated packet includes a first payload header and an extended payload header, wherein the first payload header includes an indication of whether the extended payload header is present; and
a transceiver for transmitting the packet to another device.

28. The device of claim 27, wherein the packet is a synchronous connection oriented packet (SCO) and the payload data section includes voice data, user data and signaling data, wherein the signaling data is not related to the voice data in the payload data section.

29. The device of claim 27, wherein the packet is an asynchronous connectionless (ACL) packet and the payload data section includes user data and signaling data.

30. The device of claim 27, wherein the processor in forming the extended payload header includes an indication in the extended payload header of a length of the signaling data in the payload data section.

31. The device of claim 30, wherein the processor includes an indication of a length of the payload data section in the packet, thereby implicitly indicating the size of the user data portion in the payload data section.

32. The device of claim 27, wherein the signaling data includes inter-network scheduling messages, intra-network scheduling feedback, co-ordination of inquiry scan and page scan schedules or quality of service (QoS) indications.

33. The device of claim 27, wherein the first payload header includes a logical channel field, the logical channel field indicating whether the extended header is present.

34. The device of claim 33, wherein the processor generates a second logical channel field in the extended header, the second logical channel field indicating the logical channel of the user data.

35. The device of claim 33, wherein the logical channel field has a value of ‘00’ if the extended header is present.

36. The device of claim 27, wherein the processor in generating the packet inserts the signaling and user data into the payload data section, wherein only a single piece of signaling data can be inserted into the payload data section and the single piece of signaling data is preceded by an indication of an entity in the another device which is an intended recipient of the signaling data.

37. The device of claim 27, wherein the processor in generating the packet inserts the signaling and user data into the payload data section, wherein each piece of signaling data is inserted into the payload data section subsequent to an indication of an entity in the another device which is an intended recipient of the piece of signaling data and the length of the piece of signaling data.

38. The device of claim 37, wherein processor in inserting the signaling and user data into the payload data section generates an extended header preceding each piece of signaling data, the extended header including the indication of the length of the piece of signaling data.

39. A device comprising:
a processor which determines whether another device supports packets which include both signaling and user data in a payload of a packet, wherein the processor generates a packet which includes signaling data and user data in a payload data section of the packet if the another device supports packets which include both signaling and user data in a payload of a packet, wherein the processor generates a packet which includes only signaling data in the payload data section if the another device does not support packets which include both signaling and user data in a payload of a packet; and
a transceiver which transmits the generated packet to the another device.

40. The device of claim 39, wherein the generated packet including signaling data and user data is a synchronous connection oriented packet (SCO) and the payload data section also includes voice data, wherein the signaling data is not related to the voice data in the payload data section.

41. The device of claim 39, wherein the generated packet including signaling data and user data is an asynchronous connectionless (ACL) packet.

42. The device of claim 39, wherein if the processor generates a packet which includes signaling data and user data, the processor forms a first payload header and forms an extended payload header, wherein the first payload header includes an indication of whether the extended payload header is present.

43. The device of claim 42, wherein the processor in forming the extended payload header includes an indication in the extended payload header of a length of the signaling data in the payload data section.

44. The device of claim 43, wherein the processor indicates a length of the payload data section, thereby implicitly indicating the size of the user data portion in the payload data section.

45. The device of claim 39, wherein the signaling data includes inter-network scheduling messages, intra-network scheduling feedback, co-ordination of inquiry scan and page scan schedules or quality of service (QoS) indications.

46. The device of claim 42, wherein the first payload header includes a logical channel field, the logical channel field indicating whether the extended header is present.

47. The device of claim 46, wherein the processor generates a second logical channel field in the extended header, the second logical channel field indicating the logical channel of the user data.

48. The device of claim 47, wherein the logical channel field has a value of ‘00’ if the extended header is present.

49. The device of claim 39, wherein only a single piece of signaling data can be inserted into the payload data section and the single piece of signaling data is preceded by an indication of an entity in the another device which is an intended recipient of the signaling data.

50. The device of claim 39, wherein each piece of signaling data is inserted into the payload data section subsequent to an indication of an entity in the another device which is an intended recipient of the piece of signaling data and the length of the piece of signaling data.

51. The device of claim 50, wherein the device in inserting the signaling and user data into the payload data section, generates an extended header preceding each piece of signaling data, the extended header including the indication of the length of the piece of signaling data.

52. The device of claim 39, wherein the device generates a packet which includes signaling data and user data in the payload data section only if the signaling data is less than a predetermined number of bits.
